(19) United States
(12) Patent Application Publication
(10) Pub. No.: US 2006/0003766 A1
(43) Pub. Date: Jan. 5, 2006

(54) Providing temporal information for roaming mobiles

(76) Inventors: Sriram Parameswar, Allex, TX (US); Probal Mukherjee, Plano, TX (US)

Correspondence Address: Bruce E. Garlick;Garlick Harrison & Markison, LLP, P.O. Box 167027, Austin, TX, 78716-0727, US

(21) Appl. No.: 10/881,282

(22) Filed: Jun. 30, 2004

(51) Int. Cl. H04Q 7/20

(52) U.S. Cl. 455/433; 455/432.1; 455/566; 455/414.1

(57) ABSTRACT

Providing mobile station time-based services in a cellular wireless communication network. A servicing entity initiates time-based services for the mobile station by querying a Home Location Register (HLR) serving the mobile station to return current mobile station time and time zone (TTZ) information including at least one of the mobile station's local time, local date, a time difference between Greenwich Mean Time (GMT) and the local time. The HLR queries a mobile station serving VLR for the TTZ information. Upon receipt of a TTZ response message, the HLR transmits the TTZ information to the servicing entity. The TTZ information is filtered based on at least one mobile station defined rule to derive a mobile station time-based selective presence or availability. The servicing entity provides the time-based service based on the mobile station TTZ information and the mobile station time-based selective presence.

### BACKGROUND OF THE INVENTION

1. Technical Field of the Invention

This invention relates generally to wireless communication systems and, more particularly, to time based call processing and services.

2. Description of Related Art

Initial wireless voice networks, including Advanced Mobile Phone Service (AMPS), Time Division Multiple Access (TDMA), including North American TDMA and Global System for Mobile Communications (GSM) networks, were used to carry wireless calls for a limited number of users and primarily only for voice calls. Cellular wireless networks are currently being replaced by newer wireless data-only or data-centric networks, as well as mixed data and voice networks as the wireless technology grows in popularity. The structure and operation of wireless communication systems are generally known. Examples of such wireless communication systems include cellular systems and wireless local area networks, among others. Equipment that is deployed in these communication systems is typically built to support standardized operations, i.e., operating standards. These operating standards prescribe particular carrier frequencies, modulation types, baud rates, physical layer frame structures, medium access control (MAC) layer operations, link layer operations, signaling protocols, etc. By complying with these operating standards, equipment interoperability is achieved.

In cellular systems, a plurality of base stations is distributed across the service area. Each base station services wireless communications within a respective cell. Each cell may be further subdivided into a plurality of sectors. In many cellular systems, e.g., GSM cellular systems, each base station supports forward link communications (from the base station to subscriber units) on a first set of carrier frequencies, and reverse link communications (from subscriber units to the base station) on a second set of carrier frequencies. The first set and second set of carrier frequencies supported by the base station are a subset of all of the carriers within the licensed frequency spectrum. In most, if not all, cellular systems, carrier frequencies are reused so that interference between base stations using the same carrier frequencies is minimized and system capacity is increased. Typically, base stations using the same carrier frequencies are geographically separated so that minimal interference results. In other cellular systems, such as CDMA systems, a single frequency is used to carry code divided communications.

Traditional wireless mobile networks include Mobile Switching Center (MSCs), Base Station Controllers (BSCs) and Base Station Transceiver Sets (BTSs), which jointly operate to communicate with mobile stations over a wireless communication link. The BSCs and BTSs collectively are referred to as BSs or base stations. To establish a wireless communication link in traditional wireless voice networks, the MSC communicates with the BSC to prompt the BTS to generate paging signals to a specified mobile station within a defined service area typically known as a cell or sector (a cell portion). The mobile station, upon receiving the page request from the BTS, responds to indicate that it is present and available to accept an incoming call. Thereafter, the BS, upon receiving a response from the mobile station, communicates with the MSC to advise it of the same. The call is then routed through the BS to the mobile station as the call setup is completed and the communication link is created. Alternatively, to establish a call, a mobile station generates call setup signals that are processed by various network elements in a synchronized manner to authenticate the user as a part of placing the call.

Wireless communication service providers, as well as Internet service providers, are increasingly working together to provide seamless end-to-end call connectivity across the various platforms to enable users to establish point-to-point connections independent of terminal type and location. Traditionally, however, voice networks have paved the way for the creation of data networks as users loaded the voice networks trying to transmit data, including streaming data (video and audio). Initially, traditional Public Switched Telephone Networks (PSTNs) were used for data transmissions but have been largely supplanted by packet data networks, including various versions of the Internet. The next generation of cellular networks presently being developed is being modified from traditional systems to create the ability for mobile stations to receive and transmit data in a manner that provides greatly increased throughput rates. For example, many new mobile stations, often referred to as mobile terminals or access terminals, are being developed to enable a user to surf the web or send and receive e-mail messages through the wireless channel, as well as to be able to receive continuous bit rate data, including so called “streaming data” such as sports and news. Accordingly, different systems and networks are being developed to expand such capabilities and to improve their operational characteristics. Video conferencing and instant text messaging are two such examples. There are, however, logistical problems with delivering these expanded capabilities when mobile stations are not limited to a single geographic area.

Domestic and international travel results in mobile phones geographically distant from their home network identified by the mobile phone area code or country code. Thus, callers have no way of knowing the mobile station's actual location or local time. There is a need, therefore, for a method of determining a mobile stations local time regardless of physical location.

Another innovation in delivery of wireless services (including telephony, instant messaging, presence, etc.) is the concept of availability. This concept relies on a set of rules established by the subscriber to define when and if the mobile station is available for accepting any of the fore mentioned expanded capabilities typically provided by a time-based server or serving entity. The subscribers' presence information is filtered through this set of rules and provided to interested parties—indicating the subscribers' willingness to participate in a communication session. In time based routing—phone calls, for example, may be programmed by the subscriber to be accepted only during business hours and be routed to voice mail otherwise. Optionally, after business hours the mobile station may elect to route call to a pager. If, however, the mobile station is located in a different time zone or country, the services may be delivered at an incontinent time. There is a need for providing the mobile station's time zone information along with the mobile station's current time of day.

### BRIEF SUMMARY OF THE INVENTION

To solve these problems, a method and an apparatus in a cellular wireless communications network provides time and time zone information (TTZ) to mobile station time-based services. A servicing entity including at least one of a Service Control Point (SCP), a Mobile Switching Center (MSC), and/or a presence server initiate time-based services for the mobile station. The servicing entity queries a Home Location Register (HLR) serving the mobile station to return current mobile station time and time zone (TTZ) information wherein the TTZ information includes at least one of the mobile station's local time, the mobile station's local date, a time difference between Greenwich Mean Time (GMT) and the local time.

The HLR determines a serving Visitor Location Register (VLR) of the mobile station then queries the serving VLR for the mobile station TTZ information. Upon receipt of a TTZ response message from the serving VLR, the HLR transmits the TTZ information to the servicing entity. The TTZ information is filtered based on at least one subscriber defined rule to derive a mobile station's selective presence (availability). Alternatively, the servicing entity provides the time-based service based on the mobile station TTZ information and/or the mobile station time-based selective presence.

Based on the subscriber's rules, the servicing entity provides the time-based service based when the mobile station TTZ information satisfies a first criteria and delays the time-based service when the mobile station TTZ information satisfies a second criteria. The time-based services may include establishing an audio conference call, video conference call, time-based routing of audio calls, and selective routing of audio calls based on a caller ID and time filter. Availability information—represents the subscribers' willingness to engage in communication rather than the state of his mobile equipment. Availability information is foundation of several collaboration tools—including instant messaging, audio/video conferencing etc. Availability also increases the call-completion rates for mobile service providers. This invention is useful in deriving the availability of a subscriber.

The above-referenced description of the summary of the invention captures some, but not all, of the various aspects of the present invention. The claims are directed to some of the various other embodiments of the subject matter towards which the present invention is directed. Other aspects, advantages, and novel features of the invention will become apparent from the following detailed description of the invention when considered in conjunction with the accompanying drawings.

### BRIEF DESCRIPTION OF THE SEVERAL VIEWS OF THE DRAWINGS

FIG. 1 is a functional block diagram illustrating a communication network formed according to one embodiment of the present invention;

FIG. 2 is a functional block diagram illustrating providing temporal information for roaming mobile stations according to one embodiment of the present invention;

FIG. 3 is a functional block diagram illustrating an embodiment of the present invention;

FIG. 4 is a block diagram illustrating one embodiment of a formatted time and time zone information message;

FIG. 5 is a message flow diagram illustrating signal sequence flow for providing mobile station time-based services in accordance with an embodiment of the present invention;

FIG. 6 is a functional block diagram illustrating a home location register (HLR) formed according to one embodiment of the present invention; and

FIG. 7 is a flowchart illustrating one method of the present invention.

### DETAILED DESCRIPTION OF THE INVENTION

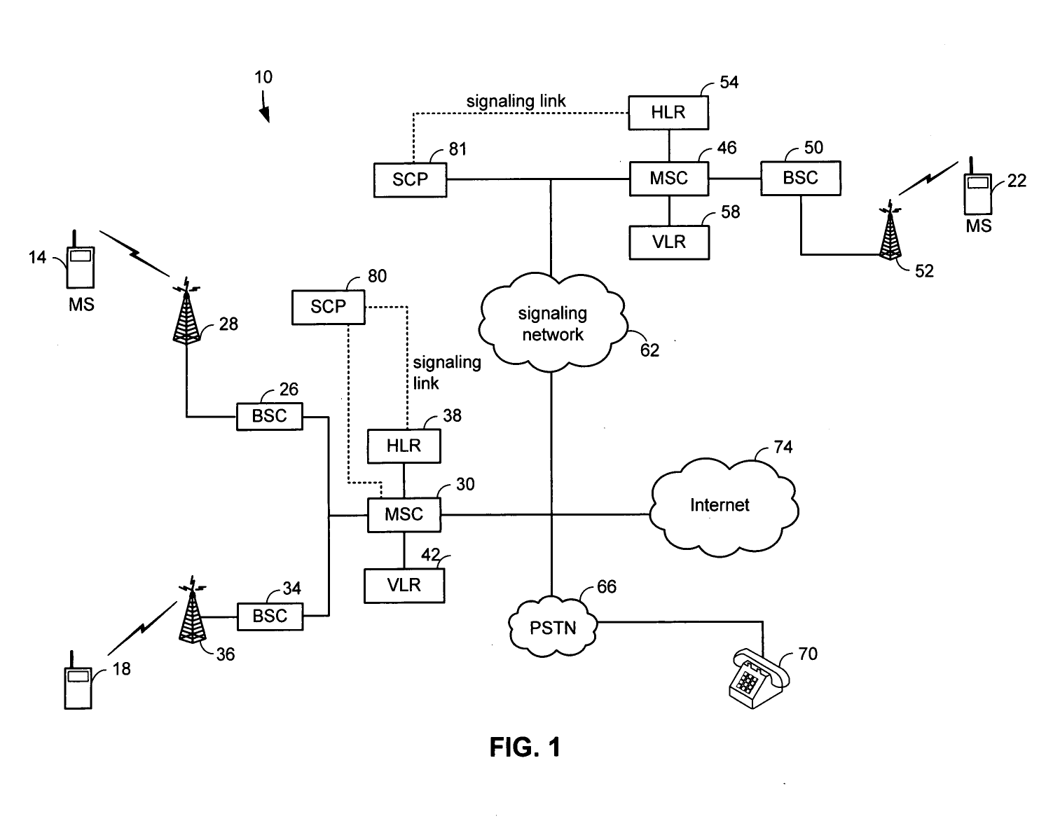

FIG. 1 is a functional block diagram illustrating a communication network formed according to one embodiment of the present invention. A communication network 10 includes many network elements that are coupled to operatively communicate with each other to enable a mobile station in one network to communicate with a mobile station in a different network. For example, communication network 10 enables a mobile station to communicate with a landline through a wireless communication link routed to the public switched telephone network.

Along these lines, a mobile station 14 is located within a geographic area served by a Base Transceiver Station (BTS) 28 that is coupled to a Base Station Controller (BSC) 26. Similarly, a mobile station 18 communicates over a wireless communication link with BTS 36 that is coupled to BTS 34. A Mobile Switching Center (MSC) 30 is operably coupled to BSC 26 and BSC 34. The MSC 30 performs the switching functions of the system and controls calls to and from other telephones and data systems. Home Location Registers (HLR) 38 and 54 provide management and storage of mobile station subscriber information and provides routing information for mobile stations. Visitor Location Registers (VLR) 42 and 58 maintain temporary information about subscribers being serviced by corresponding MSCs 30 and 46, respectively. This information is necessary for the serving MSC 30 or 46 to provide service to mobile stations. Although shown as separate network elements, the VLRs 42 and 58 are typically configured internal to the MSC.

Similarly, mobile station 22 communicates with MSC 46 through BSC 50 and BTS 52. MSC 46 and MSC 30 are, in this example, geographically separate and thus communicated over signaling network 62 that may be an SS7 signaling network.

MSC 30 further is coupled to a Public Switched Telephone Network (PSTN) 66 to allow mobile stations to communicate with landline 70. Accordingly, calls routed through MSC 30 are directed either to other MSCs, such as MSC 46 or to external networks by way of PSTN 66. The reference to PSTN herein includes SS7 and other similar “intelligent networks”. Calls, which are processed by a packet control function (not shown) are connected to a data packet network, which, in this example, comprises Internet 74.

MSC 30 and MSC 46 are connected to a Service Control Point (SCP) (SCP 80 and SCP 81, respectively). The SCPs provide services to mobile subscribers independent of their current location. The SCPs also have a signaling link with HLR 38 and HLR 54, which it uses to query for subscriber information from the HLRs. The HLRs may optionally contact the VLRs in serving networks prior to providing this information to the SCP.

As will be described in greater detail below, any one of the mobile stations may subscribe to personalized services such as time-based routing and audio and video conferencing. Time-based routing allows the mobile subscriber to define a set of rules that define if and when a call is routed to the mobile subscriber or to, for example, another phone number or to voice mail. Time-based routing and audio and video conferencing require the servicing entity performing the time-based services to have knowledge of the mobile stations local time. Assume, for example, that the network serviced by MSC 46 is several time zones distant from the network of MSC 30. If MS 14 roams to the network of MSC 46, time-based services intended for delivery to MS 14 in the home network will be off by several hours. The method and apparatus of the present invention allows the servicing entity to run time-based services based on the mobile station's local time in the visited network.

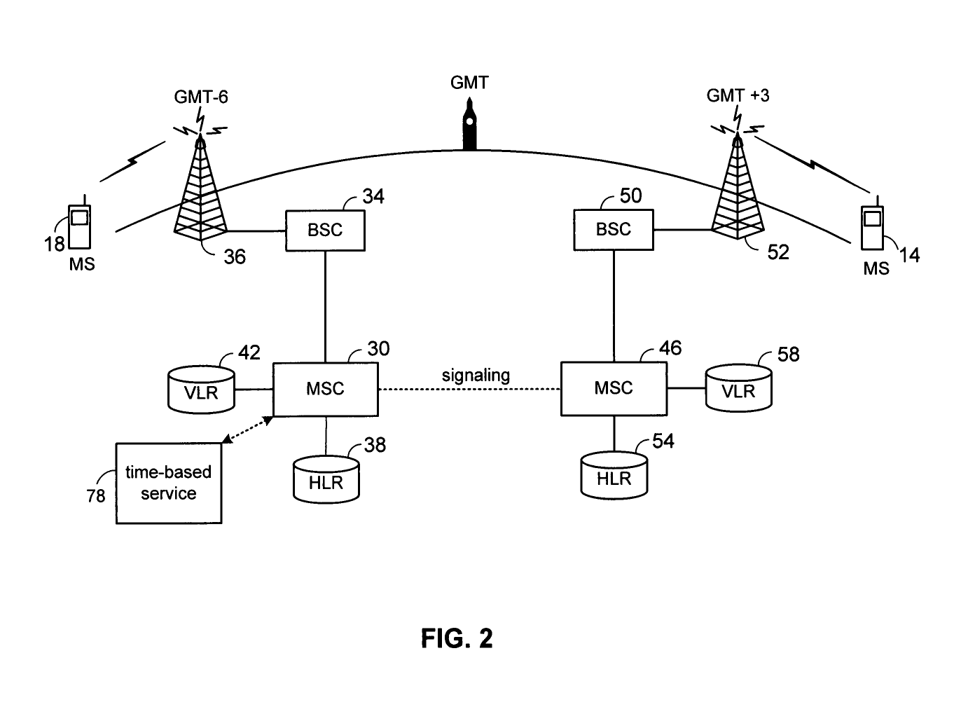

FIG. 2 is a functional block diagram illustrating providing temporal information for roaming mobile stations according to one embodiment of the present invention. MS 14 has roamed from the home network serviced by MSC 30 to the visited network service by MSC 46. In this example, the visited network is three time zones east of Greenwich Mean Time (GMT+3) while the home network is 6 time zones west of GMT (GMT−6), thus a nine hour time difference exists between the home network and the visited network. A time-based service 78 programmed to run during business hours (9 am to 5 pm) in the home network will be routed to the mobile station during the local times of 6 pm to 2 am. The method and the apparatus of the present invention ensure proper operation of time-based services by retrieving the time and time zone information (TTZ) at the current mobile station location. This information is provided, in response to a query, to the time-based server (or other servicing entity) so that time-based services run at the mobile station time specified in the mobile station subscriber profile.

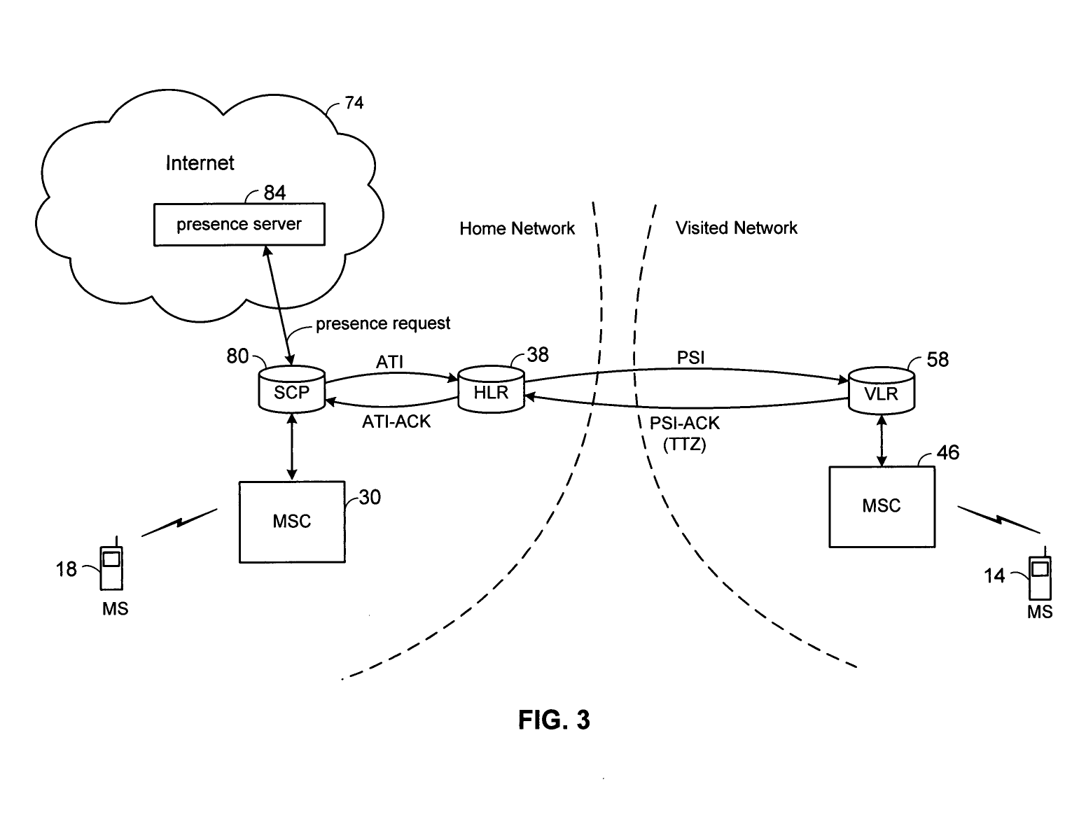

FIG. 3 is a functional block diagram illustrating an embodiment of the present invention. Mobile station 14 has roamed from the home network controlled by MSC 30 to a visited network controlled by MSC 46. MS 14 may be one or more time zones distant from the home network thus time-based services require updated TTZ information to operate correctly. HLR 38 will query serving VLR 58 in response to a presence request from presence server 84 or from an initial detection point produced by MSC 30 responsive to a call from MS 18.

Service Control Point 80 sends an Any Time Interrogation (ATI) message to HLR 38 requesting the current TTZ information for MS 14. Responsive to the query, HLR 38 sends a Provides Subscriber Information (PSI) query to serving VLR 58. After verifying the current mobile station TTZ information, VLR 58 returns a PSI acknowledge (PSI-ACK) which includes the requested TTZ information.

HLR 38 returns the TTZ information to SCP 80 in the form of an ATI acknowledge (ATI-ACK). Thereafter, SCP 80 filters the TTZ information to derive the subscribers' availability, which is used to route calls and process time-based services, or pass that information back to the Presence Server for use in a wide variety of collaboration services. The derivation of availability is based on the subscriber's rules that are maintained in at least one of the HLR 38, SCP 80, or presence server 84.

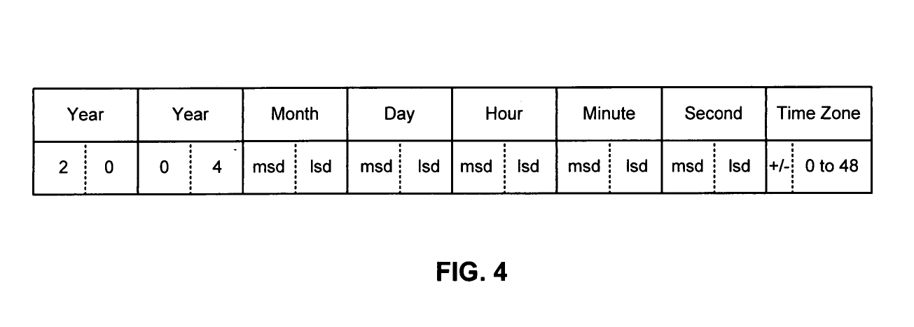

FIG. 4 illustrates one embodiment of a formatted time and time zone information message. In response to a query by the HLR, the VLR for the serving MSC returns the TTZ information in an eight byte field containing mobile station current local time, date, and time zone. Each of the first seven bytes is divided into a high and low nibble (4 bits) wherein each nibble represents a binary encoded decimal (BCD) number. The first byte of the eight byte field includes the millennium and century while the second byte includes the decade and year. Each byte for the month, day, hour, minute, and second are divided into two nibbles representing a most significant digit (msd) and a least significant digit (lsd). The hour byte is encoded in 24 hour format. The first bit of the time zone byte is coded as an algebraic sign (+/−) and the remaining bits indicate the difference, expressed in quarters of an hour between the local time and GMT. As is known to one of average skill in the art, GMT is the prime meridian dividing the earth into eastern and western hemispheres. Thus, a plus (+) sign represents time zones east of GMT while a minus (−) sign represents time zones west of GMT.

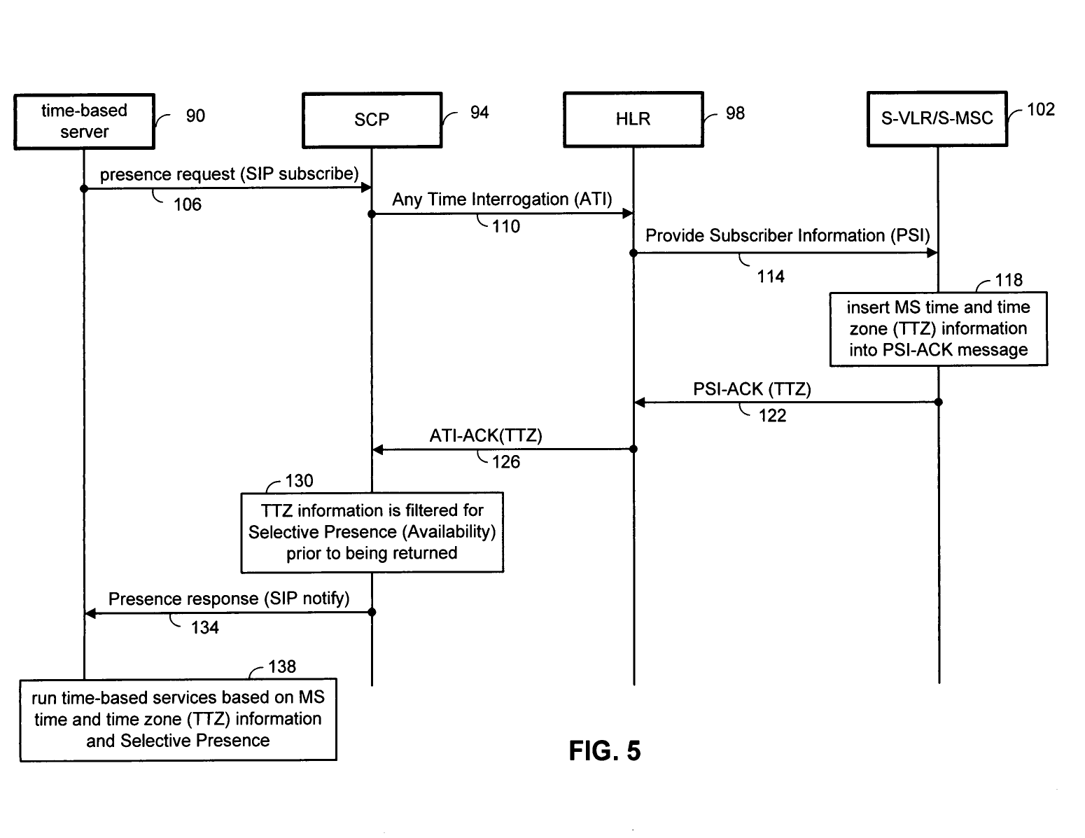

FIG. 5 illustrates signal sequence flow for providing mobile station time and time zone information in accordance with an embodiment of the present invention. A time-based server 90 initiates a time-based service by sending a presence request using a Session Initiation Protocol (SIP) 106 to a Service Control Point (SCP) 94. The SCP sends an Any Time Interrogation (ATI) 110 to HLR 98. The HLR 98 determines the mobile station has roamed to a visited network and sends a Provided Subscriber Information (PSI) 114 query to the serving VLR (S-VLR) through the serving MSC (S-MSC) 102.

The S-VLR inserts the current mobile station TTZ information 118 into the PSI acknowledge (PSI-ACK) 122. As was previously discussed, the TTZ information includes the mobile station local time, date, and time zone information. HLR 98 returns the TTZ information to the SCP by way of an ATI acknowledge (ATI-ACK) 126. SCP 94 filters the received TTZ information 130 based on at least one mobile station defined rule to produce a mobile station selective presence prior to returning the information in a Presence Response 134. Alternatively the TTZ information may be passed back to the Presence Server for further processing there. Thereafter, the time-based server runs time-based services based on at least one of the mobile station TTZ information and the selective presence.

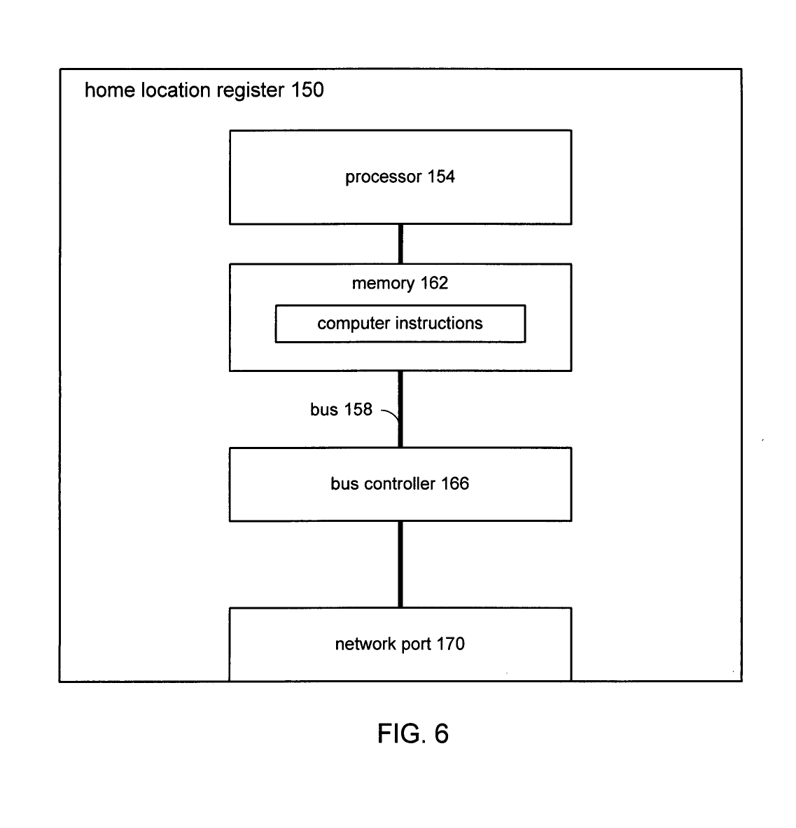

FIG. 6 is a functional block diagram illustrating a home location register (HLR) formed according to one embodiment of the present invention. HLR 150 includes a processor 154 that is coupled to communicate over a bus 158. A memory 162 further is coupled to bus 158 and is for storing computer instructions that define the operational logic of HLR 150. Bus 158 further is coupled to a bus controller 166, which controls the communications and timing of communications thereon. Bus controller 166 is further coupled to a network port 170 that enables HLR 150 to communicate with network elements in a wireless communication network.

In operation, processor 154 communicates with memory 162 by way of bus 158 to retrieve computer instructions stored therein and to execute the computer instructions to operate according to the logic defined within the computer instructions of memory 162. Memory 162 includes computer instructions that define logic for processing a mobile station update query from a time-based server. Memory 162 also includes computer instructions that define the logic for determining a serving VLR for a mobile station that has roamed to a visited network. Memory 162 further includes instructions defining logic for querying the serving VLR to return the current mobile station TTZ information, processing a received TTZ response message from the serving VLR, and providing the TTZ information to the time-based server.

Memory 162 further includes instructions defining logic for receiving and processing one of a provide subscriber information (PSI) message and an any time interrogation (ATI) message from the time-based server. Additional instructions define logic for filtering the TTZ information based on at least one mobile station defined rule to derive a mobile station time-based selective presence and for providing the selective presence to the time-based server.

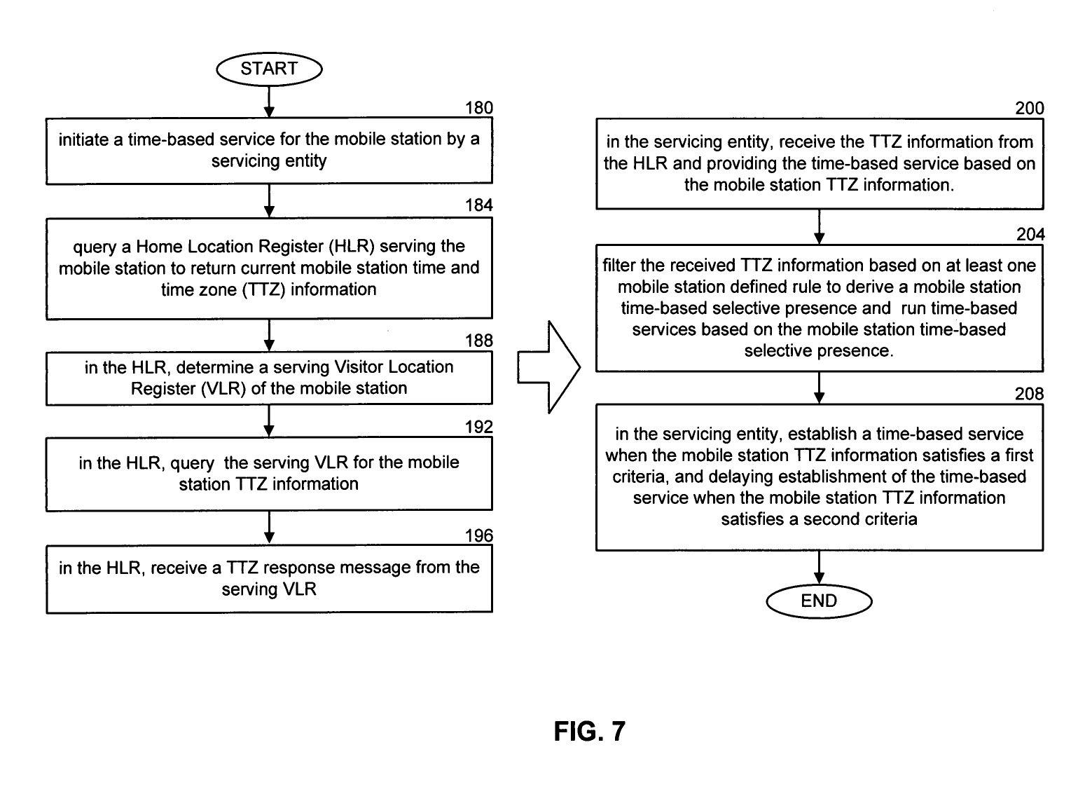

FIG. 7 is a flowchart illustrating one method for providing mobile station time-based services comprises. A time-based service for the mobile station is initiated by a servicing entity (step 180). The time-based service may be initiated by a phone call intended for the mobile station or may be initiated by one of a mobile switching center, a service control point, and a presence server. After initiation, the servicing entity queries a Home Location Register (HLR) serving the mobile station to return current mobile station time and time zone (TTZ) information (step 184). The TTZ response message includes at least one of a mobile station's local time, a mobile station's local date, a time difference between Greenwich Mean Time (GMT) and the local time. The HLR, in response to the query, determines a serving Visitor Location Register (VLR) of the mobile station (step 188) then the HLR queries the serving VLR for the mobile station TTZ information (step 192). Following the query, the HLR receives a TTZ response message from the serving VLR (step 196).

Thereafter the servicing entity receives the TTZ information from the HLR and proceeds to provide the time-based service based on the mobile station TTZ information (step 200). After the TTZ information is received, filter the received TTZ information based on at least one mobile station defined rule to derive a mobile station time-based selective presence and/or running time-based services based on the mobile station time-based selective presence (step 204). Based on the time-based selective presence, the servicing entity provides the time-based service when the mobile station TTZ information satisfies a first criteria and delays the time-based service when the mobile station TTZ information satisfies a second criteria (step 208). The time-based services may include establishing an audio conference call, video conference call, time-based routing of audio calls, and selective routing of audio calls based on a caller ID and time filter. The servicing entity may also disseminate the availability information to subscribers or other entities that requested the information, thus enabling a wide variety of collaboration services.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A method in a cellular wireless communications network for providing mobile station time-based services comprises:
initiating a time-based service for the mobile station by a servicing entity;
querying a Home Location Register (HLR) serving the mobile station to return current mobile station time and time zone (TTZ) information;
the HLR determining a serving Visitor Location Register (VLR) of the mobile station;
the HLR querying the serving VLR for the mobile station TTZ information;
the HLR receiving a TTZ response message from the serving VLR;
the servicing entity receiving the TTZ information from the HLR; and
the servicing entity providing the time-based service based on the mobile station TTZ information.

2. The method of claim 1 wherein the servicing entity comprises one of:
a Service Control Point (SCP);
a Mobile Switching Center (MSC); and
a presence server.

3. The method of claim 1 wherein initiating and providing the time-based service comprises:
the servicing entity receiving a call intended for the mobile station;
the servicing entity completing the call to the mobile station when the mobile station TTZ information satisfies a first criteria; and
the servicing entity delivering the call to voice mail or any alternative number when the mobile station TTZ information satisfies a second criteria.

4. The method of claim 1 wherein providing the time-based service comprises:
filtering the received TTZ information based on at least one mobile station defined rule to derive a mobile station time-based selective presence; and
the servicing entity running time-based services based on the mobile station time-based selective presence.

5. The method of claim 1 wherein the TTZ response message includes:
the mobile station's local time; and
the mobile station's local date.

6. The method of claim 1 wherein the TTZ response message includes:
a time difference between Greenwich Mean Time (GMT) and the local time.

7. The method of claim 1, further comprising:
the serving VLR receiving the query from the HLR;
the serving VLR determining a local time of the mobile station;
the serving VLR determining the TTZ response based upon the local time of the mobile station; and
the serving VLR transmitting the TTZ response message to the HLR.

8. The method of claim 1, wherein the servicing entity providing the time-based service based on the mobile station TTZ information comprises:
establishing an audio conference call with the mobile station when the mobile station TTZ information satisfies a first criteria; and
delaying establishment of the audio conference call with the mobile station when the mobile station TTZ information satisfies a second criteria.

9. The method of claim 1, wherein the servicing entity providing the time-based service based on the mobile station TTZ information comprises:
establishing a video conference call with the mobile station when the mobile station TTZ information satisfies a first criteria; and
delaying establishment of the video conference call with the mobile station when the mobile station TTZ information satisfies a second criteria.

10. The method of claim 1, wherein the servicing entity providing the time-based service based on the mobile station TTZ information comprises:
establishing collaboration services including at least one of application and file sharing with the mobile station when the mobile station TTZ information satisfies a first criteria; and
delaying establishment of the collaboration services including at least one of application and file sharing with the mobile station when the mobile station TTZ information satisfies a second criteria.

11. A Home Location Register (HLR) comprises:
a processor for executing computer instructions;
a bus; and
a memory for storing the computer instructions, wherein the computer instructions include logic for:
processing a mobile station update query from a time-based server;
determining a serving Visitor Location Register (VLR) of the mobile station;
querying the serving VLR for the mobile station to return current mobile station time and time zone (TTZ) information;
processing a received TTZ response message from the serving VLR; and
providing the TTZ information to the time-based server.

12. The HLR of claim 11 wherein the time-based server comprises one of:
a Service Control Point (SCP) and a Presence Server.

13. The HLR of claim 11 wherein the logic for processing a mobile station update query from a time-based server further comprises logic for receiving and processing a provide subscriber information message from the time-based server.

14. The HLR of claim 11 wherein the logic for processing a mobile station update query from a time-based server further comprises logic for receiving and processing an any time interrogation message from the time-based server.

15. The HLR of claim 11 wherein the logic for processing a mobile station update query from a time-based server further comprises logic for receiving and processing a send routing information request message from the time-based server.

16. The HLR of claim 11 wherein the computer instructions further comprises logic to:
return the mobile station's local time;
return the mobile station's local date; and
return a time difference between Greenwich Mean Time and the local time.

17. The HLR of claim 1 wherein the computer instructions further comprises logic for:
filtering the received TTZ information based on at least one mobile station defined rule to derive a mobile station time-based selective presence; and
providing the selective presence information to the servicing entity running time-based services.
